(19) United States
(12) Patent Application Publication
(10) Pub. No.: US 2015/0134534 A1
(43) Pub. Date: May 14, 2015

(54) Software Protection Method for Preventing Unauthorized Usage

(71) Applicants: Clarence Edwin Lai, Wakefield, MA (US); Emerald Frannie Lai, Wakefield, MA (US); Rodwitt Hansin Lai, Wakefield, MA (US)

(72) Inventors: Clarence Edwin Lai, Wakefield, MA (US); Emerald Frannie Lai, Wakefield, MA (US); Rodwitt Hansin Lai, Wakefield, MA (US)

(21) Appl. No.: 14/080,477

(22) Filed: Nov. 14, 2013

(51) Int. Cl. G06F 21/10; G06Q 50/18

(52) U.S. Cl. CPC G06F 21/105; G06Q 50/184; G06Q 2220/18
USPC 705/59

(57) ABSTRACT

A method of protecting a software program from unauthorized usage is presented. At startup, the program reads an encrypted license file. The license file contains the computer name for an individual license or the domain name for a group license. The program matches the computer name or the domain name in the license file against the computer name or domain name of the computer. If a name match exists, the program will run normally. Otherwise, the program closes immediately or runs with limited functionality. The license file is prepared based on the computer name or domain name submitted to the vendor website. The program displays the computer name and domain name for the user to copy-and-paste the name onto a webpage. The program may also provide a function to send the computer name or domain name without webpage interaction to the vendor website. After making the payment, the user downloads the license file from a webpage. The program may also provide a function to request and receive the license file without webpage interaction and save the license file into the designated folder.

### FIELD OF THE INVENTION

The present invention relates generally to software protection, and more specifically, to the protection of distributed software from unauthorized usage. The present invention also relates to the method and procedure of establishing an authorization system for software usage on an individual computer or a group of computers.

### BACKGROUND OF THE INVENTION

This invention is about a method of protecting a software product from unauthorized usage. Many methods have been used in the past. Some of them prevent the software from being duplicated or reverse-engineered. Some of them encrypt the software such that certain keys are required to decrypt the software before it can be run on a computer. Some of them require an encoded hardware device connected to the computer communication port in order to run the software. Some of them use a one-time qualification process to install the software, such as entering a long valid serial number provided with each copy of the product and allowing the software to run normally without any validation thereafter. The present invention does not use any of these types of protection.

This invention uses an encrypted file that encodes a few keywords to authorize the usage of the program. This encrypted file is referred to as the license file here. During or after the opening of the program, the program reads this license file and decrypts it to decode the keywords. The program then matches these keywords against the properties associated with the computer and the program. If they match, the license file is valid and the program is allowed to run normally. If they do not match, the program will be closed immediately or allowed to perform limited functionalities only.

This type of protection has been used in the past. Most of them use sophisticated methods to achieve full protection. They made it difficult for anyone to do reverse engineering of the license file and to fabricate a valid license file for unauthorized usage. This invention takes different approach. It is a simple process to prepare the license file. But it does not achieve full protection. However, for certain applications, the simpler process is more important than full protection. This invention is targeted at these applications. For these applications, the product vendor and the users may prefer this invention.

Many factors determine the quality and practicality of a protection method. They include the complexity of user interaction, the reliability of user interaction, the effectiveness of the protection, and the invasion of computer privacy and Internet privacy. Raising the merit in one factor often compromises the merit in other factors.

The present invention suggests a protection method that offers relative simple and reliable user interaction. It does not provide perfect protection but achieves a reasonable level of protection. It does not violate computer privacy and Internet privacy. It uses a license file containing the encrypted program name and the computer name or the domain name. At opening of the program, the program checks the computer name or domain name in the license file against the computer name or domain name registered in the computer system. The program also checks the program name in the license file against the current program and its version number.

This invention uses a simple procedure for the user to copy the computer name or domain name from the program and to paste it to the Internet webpage. This invention also suggests a simple procedure for the user to download a test file from the webpage to the user's computer. The program provides a simple means for the user to verify the entered computer name or domain name in the test file against the computer name or domain name registered in the computer. This invention also suggests the program to initiate and perform the purchasing and installation of the license file via Internet communication with the vendor website without user webpage interactions.

### SUMMARY

This invention suggests a method of protecting a software program from unauthorized usage. The software program requires an encrypted license file containing the computer name or the domain name of the computer to run normally with full functionalities. In the process of purchasing the license file, the user enters the computer name for individual license, or the domain name for group license, to the Internet webpage. To facilitate the process, the software program displays the computer name and domain name, and allows the user to copy the computer name or the domain name to the computer clipboard. The user can then paste the computer name or domain name from the computer clipboard to the webpage input box. Based on the input computer name or the domain name, the webpage prepares an encrypted license file and provides a means for the user to download the license file into a designated folder.

In addition, before entering the payment process, the user can download a test file containing the input computer name or domain name in the same procedure as download the license file. The software program provides a means for the user to verify the computer name or domain name in the test file against the computer name or domain name registered in the computer before making payment. The software program then displays the verification result. From which, the user can continue in order to make payment and download the license file, or they can cancel the purchasing process.

This invention also suggests method of purchasing and installation of the license file by the program. The program first sends an Internet web request to the vendor website for purchasing the license and submits the program name, the license type, and the computer name or domain name. At completion of the payment process, the program sends another Internet web request for installing the license file and submits the order number and possibly the computer name or domain name.

### BRIEF DESCRIPTION OF THE DRAWINGS

FIG. 1 illustrates the process of obtaining an individual license file. The flow of the software program is shown on the left-hand side. It displays the computer name and provides buttons for the user to copy and verify the computer name. The flow of the Internet webpage is shown on the right-hand side. It receives the computer name, prepares the license file, processes payment, allows the user to download an optional test file for verifying the computer name, and allows the user to download the license file.

FIG. 2 illustrates the process of obtaining a group license file. The flow of the software program is shown on the left-hand side. It displays the domain name and provides buttons for the user to copy and verify the domain name. The flow of the Internet webpage is shown on the right-hand side. It receives the domain name, prepares the license file, processes payment, allows the user to download an optional test file for verifying the domain name, and allows the user to download the license file.

FIG. 3 illustrates the steps for the software program to protect it from unauthorized usage. When the program is opened, it finds and decrypts a license file in the designated folder. It checks the computer name or the domain name in the license file. It allows the program to run in normal operation only when the license file is successfully validated.

FIG. 4 illustrates the workflow for the software program to initiate and perform the purchasing and installation of the license file.

### DETAILED DESCRIPTION

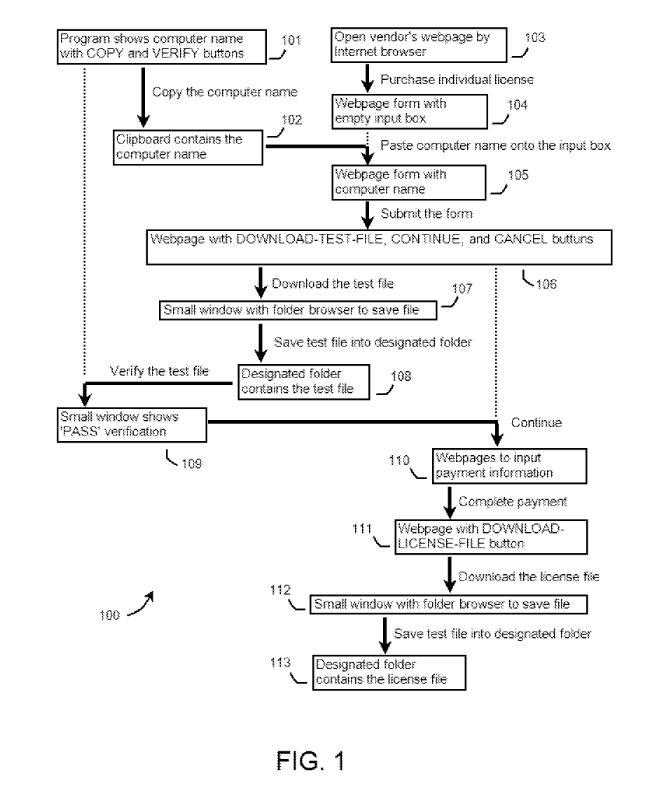

In this invention, a license file is needed for the software program to run as a normal program with full functionalities. The program can be installed into any computer without the license file. The program can be opened without the license file. Without the license file, the program can still perform certain basic functions. During installation of the operation system, each computer is assigned and registered with a computer name. The computer name must be unique among the computers in the same local network. The program can display the computer name. The displayed computer name can be copied to the clipboard, by selecting the text from the display box and copying it to the clipboard, which is usually done by pressing the keyboard Ctrl-C key. Preferably, the program provides a ‘Copy’ button for the user to copy the computer name. When this button is clicked, the program writes the computer name to the clipboard. In FIG. 1, the program and the clipboard are shown in 101 and 102 respectively.

The user purchases and downloads the license file for the program from the vendor's website, as shown in 103. In the process, the website displays a webpage form and requests the user to enter his or her computer name, as shown in 104. The user can type in the computer name directly. Preferably, the user copies the computer name to the clipboard as described above, and then pastes the clipboard text to the webpage form input box, which is usually done by pressing the keyboard Ctrl-V key. The computer name will appear on the input box. The user can proof-read the entered computer name before submitting the form. This is shown in 105 of FIG. 1.

When the form is received, the website displays a webpage for the user to continue the purchasing process by click a button or cancel the purchasing process by click another button. This webpage is shown in 106 of FIG. 1. The page also suggests the user to first verify the entered computer name by downloading a test file into a designated folder, preferably one of the folders created by the installation of the program. The test file is prepared based on the user entered computer name and the purchasing program name indicated in the webpage. When the user clicks the ‘Download-test-file’ button, a window appears with folder browser for the user to find the designated folder in the user computer and save the test file into that folder. This step is shown in 107. The designated folder now contains the test file as shown in 108.

The program provides a ‘Verify’ button in addition to the ‘Copy’ button mentioned above. After saving the test file into the folder, the user clicks the ‘Verify’ button to execute a software function that reads in the test file and verifies the computer name contained in the test file against the computer name registered in the computer. Of course, it also verifies the program name contained in the test file against this program name and version number. The program displays a message to indicate ‘pass’ or ‘fail’ the verification, as shown in 109. The message provides the user the confidence to continue or cancel the purchasing process. In addition, downloading the test file allows the user to gain experience saving the license file into the designated folder.

The test file is useful for a first-time user to ensure the computer name is entered correctly before committing to the purchase. An experienced user may opt to skip the downloading and verification of the test file in steps 107, 108, and 109. The experienced user may also enter the computer name directly and skip the step 102 of copying the computer name from the program.

If the user continues the process, the license file is prepared according to the entered computer name and the purchasing program name. Other information, such as the license type, the date, and the user Internet address may also included in the license file. They may be used for further validation of the file. The content of the license file is encrypted. The user then goes through one or more webpages to enter payment related information and to get the payment authorized, which is summarized in one block 110. After the user completes the purchasing process, the website displays a page for the user to download the license file into a designated folder, preferably one of the folders created by the installation of the program. The webpage with ‘Download license file’ button is shown in 111. When the user clicks this ‘Download-license-file’ button, a window appears with folder browser for the user to find the designated folder in the user computer and save the license file into that folder. This step is shown in 112. The designated folder now contains the license file as shown in 113.

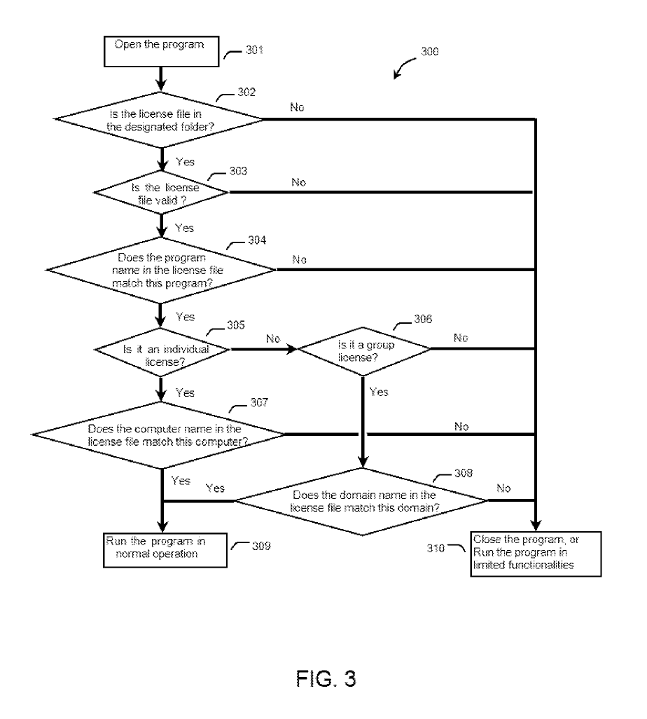

Every time the user opens the program, the program will read the license file from the designated folder. This is shown in 301 and 302 of FIG. 3. If the license file exists, the content is decrypted. If the license file is not a valid file in 303, the program exits immediately or runs with restricted functionalities in 310. Otherwise, the program name contained in the license file is matched against the current program as indicated in 304. If the license type contained in the license file is an individual license, the computer name contained in the license file is matched against current computer. These two steps are shown in 305 and 307. If they are matched, the program can operate in normal mode to perform all functionalities, as shown in 309. Otherwise, the license file is invalid and program performs limited or no function at all, as shown in 310.

The license file with computer name authorizes an individual computer to use the program. It is an individual license. The present invention also suggests a license file to authorize a group of computers to use the program. The webpage provides the option for the user to purchase a group license file. It is called a group license.

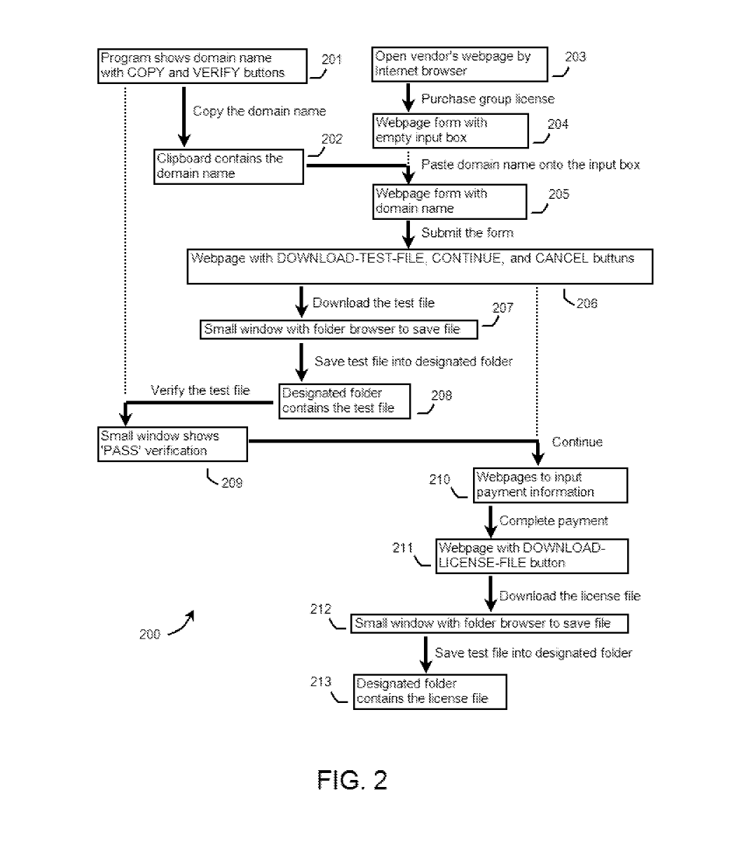

When multiple computers are connected within an Intranet network and have a common Internet domain, as the office computers in an organization, these computers share a domain name. In the present invention, the program can display the domain name, in addition to the computer name described above. The program also provides a ‘Copy’ button and a ‘Verify’ button to work with the domain name. This is shown in 201 of FIG. 2.

When the user selects group license, the website displays a webpage form and requests the user to enter his or her domain name, shown in 203 and 204. The user can type in the domain name directly. Preferably, the user copies the domain name to the clipboard shown in 202, and then pastes the clipboard text to the form input box shown in 205, as in the case of purchasing an individual license. The entered domain name is visible on the input box. The user can proof-read the entered domain name before submitting the form, as shown in 206.

Like the individual license case, when the form is received, the website displays a webpage and suggests the user to first verify the entered domain name by downloading a test file into the designated folder. The test file is prepared based on the user entered domain name. The test file also includes the program name and specifies it is a group license. When the user clicks the ‘Download-test-file’ button, a window appears with folder browser for the user to find the designated folder in the user computer and save the test file into that folder. This step is shown in 207. The designated folder now contains the test file shown in 208.

The program provides a ‘Verify’ button in addition to the ‘Copy’ button to work with the domain name. After saving the test file into the designated folder, the user clicks the domain ‘Verify’ button to execute a software function that reads the test file and verifies its domain name against the domain name registered in the computer. The program shows a message to indicate ‘pass’ or ‘fail’ the verification, as shown in 209. The message assists the user to select and click ‘Continue’ or ‘Cancel’ button accordingly. In addition, it allows the user to rehearse the process of saving the license file into the same folder to be done later.

If the user continues the process, the license file is prepared according to the entered domain name, the purchasing program name, and the group license type. Other information, such as the date and the user Internet address may also included in the license file. The user then goes through one or more webpages to enter payment related information and to get the payment authorized, which is summarized in one block 210. After the user complete the purchasing process, the website displays a page for the user to download the license file into a designated folder, preferably one of the folders created by the installation of the program. The webpage with ‘Download license file’ button is shown in 211. When the user clicks this ‘Download-license-file’ button, a window provides a folder browser for the user to find the designated folder in the user computer and save the license file into that folder. This step is shown in 212. The designated folder now contains the license file as shown in 213.

Every time when the user opens the program, the program reads the license file from the designated folder and goes through the verification process in 300. If the license type contained in the license file is not an individual license, the license type is verified for a group license, shown in 306. If it is a group license, the domain name contained in the license file is matched against the domain name of current computer, as shown 308. If they are matched, the program can operate in normal mode to perform all functionalities, as shown in 309. Otherwise, the license file is invalid and the program can only perform limited functions or no function at all, as shown in 310.

The group license file can be distributed to any computer under the same domain and stored in the designated folder. With the group license file in the designated folder, any computer under the same domain name recorded in the license file can run the program in normal mode.

In another embodiment of the invention, the individual license file uses the computer MAC address, instead of the computer name, to identify the owner's computer. The MAC address is associated with the computer network access hardware. It is very much a unique number. In this embodiment, the program displays the MAC address and provides ‘Copy’ and ‘Verify’ button, as in the case of license based on computer name, for the user to specify the individual license file.

In yet another embodiment of the invention for individual license, the program generates a rather random and unique password and registers the password into the system during the installation of the program or when the program is opened without a valid license file. The program displays this password and provides ‘Copy’ and ‘Verify’ button, as in the case of license based on the computer name, for the user to specify the individual license file. If a computer does not have the matched password in the computer registry system, the license file is not valid. The program is thus protected from unauthorized usage, unless the unauthorized user can duplicate the license file, decipher the encrypted password in the license file, and knows how to register this password into a specific location in the computer registry system.

In addition to the issuing of the license file, the present invention also suggests a method to re-issue the license file. The purchased license file can be obtained again in cases the user inadvertently closes the webpage before downloading the license file, the Internet loses connection unexpectedly, the user fails to install the license file successfully, the installed license file got deleted by accident, or other reasons. When the user completes the payment for the license file, a webpage with Download-License-File button appears, as shown in 111 and 211. This webpage also displays a receipt number and ask the user to write down and store the receipt number in a safe place for future reference of the transaction. The vendor website home page contains a link to a webpage for re-issuing the license file. The Re-issue webpage contains a form with an input box for the user to enter the receipt number and another input box for the user to enter the computer name for individual license or the domain name for group license. When the user submits the filled form, the website checks the received receipt number and the computer name or domain name against the record in the database. If the number and name matches that in the database, the license file is prepared and the webpage with Download-License-File button, shown in 111 and 211, opens for the user to download and save the license file as it was first purchased.

This invention further suggests that if the entered receipt number and the computer name or domain name do not match the record in the database, a license file is also prepared and the webpage with Download-License-File button, shown in 111 and 211, opens for the user to download and save the license file as it was first purchased. In this case, an arbitrary name different from the entered computer name or domain name is used to prepare the license file. When the program opens, this license file will be rejected in 303, 304, 307, or 308. This scheme deters a prospective hacker from stealing a valid license file by entering the intended computer name or domain name and trying a series of receipt numbers until it matches a record in the database. If the website rejects the unmatched receipt number by closing the webpage or displaying a message, the hacker can use that event to automate the process of entering different receipt numbers until it hits the matched record in the database. With the suggested scheme, the hacker has to open the program and test the license file before the next receipt number is tried. This makes the automated hacking difficult.

In re-issuing the license file, the vendor can also issue a license file for a different computer name, after the receipt name and the original computer name are verified. In this case, the license file is prepared like the original file but with a different computer. The vendor may of course maintain a log of user purchases to limit the number of additional computer names to be issued. This feature allows the user to purchase one license and obtain multiple license files for authorizing the program in multiple computers.

In another approach, this invention suggests that the computer name in the license file can be a list of multiple computer names. Any computer matching a computer name in the list is authorized to use the program. This method allows the user to purchase one license and use the same license file for multiple computers. The user can still download the test file and copy it to other computers for verification.

In some computer operating system, a name is assigned to the computer but is not referred to as the computer name. This assigned name is considered as the computer name in this invention. The operating system may also assign an identification number to the computer. Such identification number can be considered and used as the computer name in this invention.

In another embodiment of the invention, the license file contains multiple names associated with a computer. The computer must match these multiple names, such as computer name and computer identification number, listed in the license file before it can run the program normally. In this case, the program is most likely targeted at an application under this type of operating system.

The purchasing, acquisition, and installation of the license file described above are based on user interaction with webpages shown in 100 and 200. Another embodiment of this invention is to initiate and perform this process by functionality of the program. In this approach, the program initiates Internet communication function via Application Program Interface (API) and passes required data. This method largely reduces the user effort and interaction with the webpages to purchase and install the license file. The process can be divided into three steps. In step one, the program initiates an Internet web request to purchase the license and submits relevant data. In step two, the user fills the payment required data on webpages to get the payment authorized by the user's bank. In step three, the program initiates another Internet web request to transfer the license file content and saves it into the designated folder as the license file. The workflow of this method is delineated in 400.

In this approach, the program provides options for the user to select the license type, purchase the license, and install the license, as shown in 401. When the user clicks the Purchase-License button, the program sends an Internet web request to the vendor website for purchasing the license and submits the license type and the computer name for an individual license or the domain name for a group license. The Internet web request is often known as HTTP request. This is shown in 402. When the vendor website receives the request, it creates a new order record and stored it in the database. It then sends the Internet web response back to the user program containing the order number. The Internet web response is often known as HTTP response. This is shown in 403. When the program receives the Internet web response, the program saves the order number into a disk file as shown in 404. The program then invokes an Internet browser, such as Microsoft Internet Explorer, to open a vendor webpage and submit the order number, shown in 405. This is similar to submit the webpage form in 105 or 205, except here the program initiates it and submits the order number instead of the computer name or the domain name. When the vendor webpage receives the request, it reads the order record in the database based on the order number. It prepares a set of data from the record and forwards the user request to a bank website with the prepared data, as shown in 406.

The bank website then sends one or more webpages back to the user Internet browser for the user to input the payment related data. This is shown in 407, and it is the same webpages and process shown in 110 and 210. When the payment procedure is completed, the bank website sends the vendor web response containing payment status and other data. If the status indicates successful transaction, the vendor website updates the record in the database and assigns the order number as the receipt number. The vendor website then sends back to user Internet browser to indicate successful payment authorization and display the recipe number. This is shown in 408. It is similar to 111 and 211, except here the DOWNLOAD-LICESE-FILE button is not needed as it is replaced by the action in the next step described below. The display of receipt number is also not necessary, because the program already has the order number, which is the same as the receipt number.

The user then clicks the Install-License button on the program. The program sends an Internet web request to the vendor website for downloading the license file and submits the order number, as shown in 409. It is not necessary but preferable to include the license type and the computer name for an individual license or domain name for a group license. Based on the order number, which is also the receipt number, the website reads the record in the database and prepares the license. The website then sends an Internet web response back to the program containing the content of the license. The program receives and stores the content of the license into the designated folder as the license file. This concludes the acquisition and installation of the license file as indicated in 410.

Although some details are described here, it is quite simple from the user point of view. The user only has to click the Purchase-License button, fill payment information, and click the Install-License button. Under this embodiment, if the user needs to have the license file re-issued, the user simply opens the program and clicks the Install-License button on the program. Like the re-issuing through webpage described earlier, the computer name or domain name is preferably submitted besides the receipt number. If the name does not matches that in the database, the website still prepares the license file with an arbitrary name different from the requesting computer name or domain name. The program still installs the license file as if it were a valid license file. This hampers the automatic sequencing of the receipt numbers to steal a matched license file.

It is worth noting that the payment procedure, in 110, 210, and 407, is only to get the payment amount authorized from the user bank. The vendor usually does not get the payment from the bank until the product is delivered. In this case, the vendor does not request the user bank to transfer payment until the user has installed the license. If the user decides to cancel the purchasing, the user can do that by not clicking the Install-License button. The program can also provide a Cancel button for the user to cancel the transaction before the license file is installed.

In the description above, the program name in the license file does not necessarily have to be the known program name. It can be a designated program name and may not even be known to the user. All that matters is that the program has this designated program name in its code. The program then verifies the program name in the license file against this designated program name in step 304. The designated computer name is considered as the computer name in this invention.

If multiple programs use the same designated computer name, then one license file can cover these multiple programs. This allows the vendor to offer a package of software programs under one license.

In another approach, this invention also suggests the program name and program version can be a list of program names and program versions. This allows the license file to be used for multiple versions of a program as well as for multiple programs in multiple versions.

In addition to the executable application programs, the license file can also be used to authorize the usage of a software library or plug-in. The software library or plug-in cannot run by itself, but it can be integrated into an executable program. When the executable program first calls it, it can process the license file, as shown in 300 of FIG. 3.

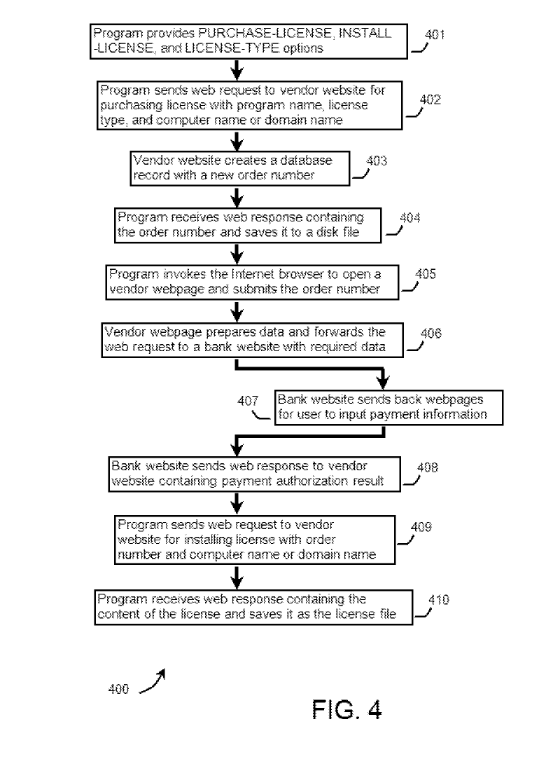

In the above description, the display, copy, and verification of the computer name and the domain name are performed by the program to be licensed, shown in 101 and 102. The vendor can provide a separate program to perform such functions. This separate program contains the designated program name and version number in its code. In this invention, this program is considered as the “Program” in 101 and 102. It can also be the “Program” in 400 of FIG. 4 to perform the purchasing and installation of the license file. It is needed for the process of purchasing software library or plug-in. It can also be used for the process of purchasing a package of software programs.

Video games are a form of software. Video games may need additional input devices in the computer and may run in a desktop computer, a mobile device, or a special console. As long as the host computer can store and read a license file, the present invention is applicable to the authorization of video game usage. A video game is considered as a type of computer program and is thus inclusive to this invention.

What is claimed is:

1. A software program protection method comprising:
a vendor webpage form to receive user computer name; and
a webpage for the user to continue or cancel the purchasing of the license; and
a license file prepared in the vendor website based on the computer name and encrypted; and
a webpage for the user to download the license file into a designated folder in the user computer; and
a software function in the program to read and match the computer name in the license file against the computer name registered in the computer system.

2. The said software program in claim 1 displays the computer name and allows the user to select the text containing the computer name and copy it to the computer clipboard.

3. The said software program in claim 1 provides a ‘COPY’ button for the user to click and thus copy the computer name to the computer clipboard.

4. In the said vendor webpage form in claim 1, the user can type in the computer name directly into the webpage input box and submits the webpage form, and the user can also paste the computer name from the clipboard onto the webpage input box and submits the webpage form.

5. The said webpage for the user to continue or cancel the purchasing of the license in claim 1 provides an option for the user to download a test file containing the entered computer name into a designated folder.

6. The said software program in claim 1 provides a ‘VERIFY’ button for the user to click and thus invoke a function to read and match the computer name in the said test file in claim 5 against the registered computer name in the computer system, and the said software program displays the matching result such that the user can decide to proceed or cancel the purchasing of the license.

7. The said license file in claim 1 contains the program name, the program version, the license type of individual license or group license, and it may also include irrelevant content to confuse reverse engineering of the license file.

8. The said software program in claim 1 closes by itself or runs with limited functionalities when it fails to find a valid license file or fails to match the computer name in the license file against the computer name registered in the computer system.

9. A software program protection method comprising:
a vendor webpage form to receive user domain name;
a webpage for the user to continue or cancel the purchasing of the license; and
a license file prepared in the vendor website based on the domain name and encrypted; and
a webpage for the user to download the license file into a designated folder in the user computer; and
a software function in the program to read and match the domain name in the license file against the domain name registered in the computer system.

10. The said software program in claim 9 displays the domain name and allows the user to select the text containing the domain name and copy it to the computer clipboard.

11. The said software program in claim 9 provides a ‘COPY’ button for the user to click and thus copy the domain name to the computer clipboard.

12. In the said vendor webpage form in claim 9, the user can type in the domain name directly into the webpage input box and submits the webpage form, and the user can also paste the domain name from the clipboard onto the webpage input box and submits the webpage form.

13. The said webpage for the user to continue or cancel the purchasing of the license in claim 9 also provides an option for the user to download a test file containing the entered domain name into a designated folder.

14. The said software program in claim 9 provides a ‘VERIFY’ button for the user to click and thus invoke a function to read and match the domain name in the said test file in claim 13 against the registered domain name in the computer system, and the said program displays the matching result such that the user can decide to proceed or cancel the purchasing of the license.

15. The said license file in claim 9 contains the program name, the program version, the license type of individual license or group license, and may also include irrelevant content to confuse reverse engineering of the license file.

16. The said software program in claim 9 closes by itself or runs with limited functionalities when it fails to find a valid license file or fails to match the domain name in the license file against the domain name registered in the computer system.

17. The said license file in claim 1 and 9 can be re-issued by providing a webpage form for the user to enter the receipt number and the computer name for individual license or the domain name for a group license, and if the entered computer name or domain does not match the name in the database record then an arbitrary name different from the entered name is used to prepare for the license file.

18. A software program protection method comprising:
a license purchasing function sending Internet web request to the vendor website for purchasing the license and receiving response data containing the order number; and
a license file prepared in the vendor website based on the order number; and
a license installation function sending Internet web request to the vendor website for installing the license file and receiving the response data containing the license file content and saving the content into the designated folder as the license file.

19. In the said license purchasing function of claim 18, it submits data including the program name, the program version, the license type, and the computer name if the license type is an individual license or the domain name if the license type is a group license.

20. In the said license installation function of claim 18, it submits data including the order number, and it may also submit the program name, the program version, the license type, and the computer name if the license type is an individual license or the domain name if the license type is a group license.

21. In preparing the said license file in claim 18, if the submitted computer name or domain name does not match the name recorded in the vendor website then an arbitrary name different from the submitted name is used to prepare the license file.

22. The said computer name in the said license file in claim 1 through 8 and in claims 19 through 21 consists of a list of computer names and any computer with computer name matching one of the computer names in the list is authorized to use the program.

23. The said computer name in the said license file in claim 1 through 8 and in claims 19 through 21 consists of multiple names for a computer, and any computer with multiple names assigned by its operating system matching the multiple names in the license file is authorized to use the program.

24. The said program name and program version in the said license file in claims 7, 15, 19, and 20 consists of a list of program names and program versions, and any program matching one of the program names and program versions in the list is authorized to use the program.

25. The functions in the said software program in claims 2, 3, 6, 10, 11, 14, as well as the said license purchasing function in claims 18 and 19, and the said license installation function in claims 18 and 19 are performed by a program associated with the software program, the software library, or the software plug-in to be licensed.

26. In the said computer name in claims 1 through 8 and in claims 19 through 21 for individual license, a password is used instead of the computer name, wherein the password is created and registered into the computer registry system during the installation of the program or when the program is opened in the absence of the license file.

27. In the said computer name in claims 1 through 8 and in claims 19 through 21 for individual license, the computer MAC address is used instead of the computer name, wherein the MAC address is a unique number associated with the computer network access hardware.
